(19) United States
(12) Patent Application Publication
(10) Pub. No.: US 2013/0197844 A1
(43) Pub. Date: Aug. 1, 2013

(54) MEASUREMENT APPARATUS

(71) Applicant: CANON KABUSHIKI KAISHA, Tokyo (JP)

(72) Inventor: Tetsuji Oota, Utsunomiya-shi (JP)

(73) Assignee: CANON KABUSHIKI KAISHA, Tokyo (JP)

(21) Appl. No.: 13/754,223

(22) Filed: Jan. 30, 2013

(30) Foreign Application Priority Data
Feb. 1, 2012 (JP) 2012-019884

(51) Int. Cl. G01B 11/24; G06F 17/10

(52) U.S. Cl. CPC G01B 11/2441; G06F 17/10
USPC 702/94

(57) ABSTRACT

A measurement apparatus includes a mount configured to mount an object, a probe configured to move with respect to the object so as to measure a shape of the object, an interferometer configured to measure a position of the probe with respect to a reference mirror, and a calculator configured to calculate the shape of the object using a measured value relating to the shape of the object that is obtained based on the position of the probe measured by the interferometer and a relative displacement between the object and the reference mirror that is obtained based on a signal from a sensor for the object and the reference mirror while the probe is moved.

### BACKGROUND OF THE INVENTION

1. Field of the Invention

The present invention relates to a measurement apparatus that measures a shape of an object to be measured.

2. Description of the Related Art

Previously, a measurement apparatus that measures a three-dimensional shape of an object by scanning a surface of the object using a probe is known. Such a measurement apparatus measures a distance between a reference mirror and the probe using an interferometer to be able to perform a highly-accurate measurement. Recently, however, when a large-size object is measured, there is a problem that a strain that is generated by deformation of amount of the object in accordance with a weight of the object is transferred to the reference mirror and also the stiffness of a driver is deteriorated as a size of the driver that drives the probe increases.

Japanese Patent Laid-Open No. 2005-17020 discloses a measurement apparatus that has a reference mirror and a mount which are separated from each other in order to prevent the transfer of the strain generated by the deformation of the mount to the reference mirror. Japanese Patent No. 4474443 discloses a measurement apparatus that mounts a micromotion stage having a high stiffness on a driver of a probe so as to improve a following capability with respect to an object.

However, as disclosed in Japanese Patent Laid-Open No. 2005-17020, a relative vibration (a relative displacement) of the reference mirror and the mount is generated when the reference mirror and the mount are separated from each other. Particularly, in measuring a large-size object, a vibration that causes a measurement noise is generated as the stiffness of the object is lowered. Even when the configuration of Japanese Patent No. 4474443 is adopted, the following capability of the driver of the probe is improved, but the measurement noise cannot be effectively removed if the object is actually vibrated.

### SUMMARY OF THE INVENTION

The present invention provides a measurement apparatus capable of measuring a shape of an object with high accuracy even when a relative displacement is generated between a reference mirror and the object.

A measurement apparatus as one aspect of the present invention includes a mount configured to mount an object, a probe configured to move with respect to the object so as to measure a shape of the object, an interferometer configured to measure a position of the probe with respect to a reference mirror, and a calculator configured to calculate the shape of the object using a measured value relating to the shape of the object that is obtained based on the position of the probe measured by the interferometer and a relative displacement between the object and the reference mirror that is obtained based on a signal from a sensor for the object and the reference mirror while the probe is moved, the sensor is an acceleration sensor that detects a relative acceleration between the object and the reference mirror, the calculator performs a second order integration of the relative acceleration so as to calculate the relative displacement between the object and the reference mirror, and corrects the measured value using the relative displacement so as to calculate the shape of the object, and the calculator removes an error component contained in corrected measured value as a translation and an inclination of the object from the corrected measured value so as to calculate the shape of the object.

Further features and aspects of the present invention will become apparent from the following description of exemplary embodiments with reference to the attached drawings.

### BRIEF DESCRIPTION OF THE DRAWINGS

FIG. 1 is a configuration diagram of a measurement apparatus in Embodiment 1.

FIG. 2 is a configuration diagram of a measurement apparatus in Embodiment 2.

FIGS. 3A to 3C are simulation results on condition that a direct-current component is not contained in the measurement apparatus in Embodiment 2.

FIGS. 4A to 4D are simulation results on condition that the direct-current component is contained in the measurement apparatus in Embodiment 2.

FIG. 5 is a diagram of describing a relation of an improvement rate of correction, the direct-current component, and an integration interval in Embodiment 2.

FIG. 6 is a diagram of describing a relation of vibration amplitude and a vibration frequency of an object that is mounted on the measurement apparatus in Embodiment 2.

FIG. 7 is a configuration diagram of a measurement apparatus in Embodiment 3.

### DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

### Embodiment 1

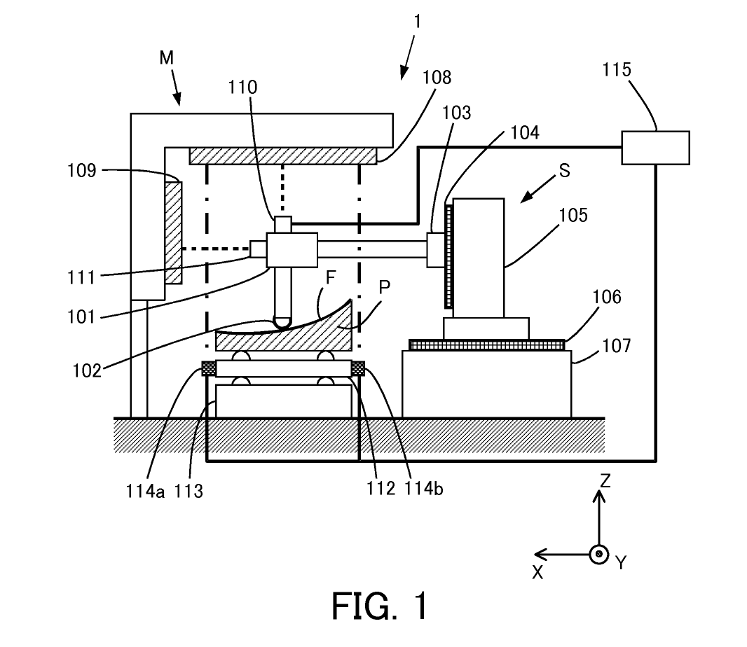

First of all, referring to FIG. 1, a measurement apparatus (a three-dimensional shape measurement apparatus) in Embodiment 1 of the present invention will be described. FIG. 1 is a configuration diagram of a measurement apparatus 1 in the present embodiment. The measurement apparatus 1 is configured by including a measurement stage S and a metrology frame M (a measurement frame), which measures a shape of a surface F of an object P to be measured (a surface shape of the object P).

The measurement stage S is configured by including a probe 101. A tip of the probe 101 is provided with a probe end ball 102, and the probe end ball 102 is moved while contacting the surface F of the object P to be able to measure a position of a contact point on the surface F (the shape of the object P). Thus, the probe 101 of the present embodiment is a contact probe that moves along the object P while contacting the object P. The probe 101 is placed on a Z stage 103. The Z stage 103 is connected to an X stage 105 via a Z actuator 104. The X stage 105 is connected to a stage platen 107 via an X actuator 106. Furthermore, the measurement stage S is provided with a Y stage and a Y actuator (not shown). In the present embodiment, the measurement stage S is configured so as to hold the probe 101 by one arm like a cantilever. However, the present embodiment is not limited to this, and the measurement stage S may also be configured so as to hold the probe 101 at both ends.

The metrology frame M (the measurement frame) holds a Z reference mirror 108, an X reference mirror 109, and a Y reference mirror that is not shown (hereinafter, collectively, also referred to as a reference mirror). Each reference mirror is polished so that its surface is a mirror surface, and it is preferred that a reflecting surface be formed by an aluminum deposition or the like.

The probe 101 includes a Z-axis interferometer 110, an X-axis interferometer 111, and a Y-axis interferometer that is not shown (hereinafter, collectively, also referred to as an interferometer). The Z-axis interferometer 110, the X-axis interferometer 111, and the Y-axis interferometer illuminate lasers (lights) on the Z reference mirror 108, the X reference mirror 109, and the Y reference mirror, respectively. Each of the interferometers can measure a distance between the Z reference mirror 108, the X reference mirror 109, or the Y reference mirror, and the probe 101, respectively. A position relation and an inclination relation of each interferometer, the probe 101, and the probe end ball 102 are previously calculated to be able to calculate coordinate information (position information) as surface shape data of the object F while the probe end ball 102 contacts the surface F. Thus, the interferometer measures the position of the probe 101 based on reflected light that is obtained by illuminating light on the reference mirror. In order to detect the inclination of the probe 101 by six degrees of freedom, a plurality of Z-axis interferometers 110, X-axis interferometers 111, and Y-axis interferometers may also be disposed.

When the relation between the interferometer and the probe end ball 102 is determined, it is preferred that so-called Abbe error be reduced. Therefore, it is preferred that the interferometer be disposed on a straight line which connects between the probe end ball 102 and a laser illumination point on the reference mirror. Alternatively, Abbe error may also be corrected by calculating the inclination of the probe 101 based on measurement results of the plurality of interferometers.

The object P is held by a measurement holder 112 that is mounted on a mount stage 113 (a mount unit) so that the probe 101 can perform a scanning on the surface F. According to such a configuration, the object P is mounted on the mount stage 113. The measurement stage S includes the Z actuator 104, the X actuator 106, and the Y actuator that is not shown (hereinafter, collectively, also referred to as an actuator). The actuator can drive (scan) the probe 101 in a state where the probe end ball 102 keeps a load of contacting the surface F constant. The probe 101 scans the object P using the actuator, and therefore the position (the coordinate) of the probe 101 along the surface F of the object P (the surface shape) can be measured.

As a unit that keeps the load that the probe end ball 102 contacts the surface F constant, a load sensor that measures the load obtained when the probe 102 is pressed on the surface F can be used. Alternatively, a displacement sensor that measures a displacement of the probe end ball 102 with respect to the probe 101 may also be used.

In the measurement apparatus 1 of the present embodiment, the metrology frame M that holds the reference mirror is provided separately from the mount stage 113. In other words, the metrology frame M and the mount stage 113 are not structurally connected to each other. In the embodiment, the object P and the measurement stage 112 are considered to be integrated with each other. When the object P is vibrated by a low eigenvalue with respect to the vibrations of the object P and the measurement holder 112, the object P vibrates with respect to the reference mirror since the metrology frame M is separated from the mount stage 113. In this case, following the surface F of the object P, the probe 101 vibrates with respect to the reference mirror. The interferometer of the present embodiment measures the position of the probe 101 with respect to the reference mirror as a surface shape of the surface F. Therefore, the vibration of the object P is contained as an error in the shape of the surface F. In this case, particularly a high-frequency component and a low-frequency component cause an error in measuring the shape of the object. Commonly, in performing a shape measurement, the accuracy that is required for a Z coordinate of X, Y, and Z coordinates is higher than each of the accuracies that are required for the X and Y coordinates. Therefore, the Z coordinate will be described in the present embodiment.

It is assumed that the object P and the measurement holder 112 are integrated so as to perform a rigid-body mode vibration. The measurement holder 112 is provided with a first displacement sensor 114a, a second displacement sensor 114b, and a third displacement sensor that is not shown (hereinafter, collectively, also referred to as a displacement sensor or a sensor). The displacement sensor detects a distance (a relative distance) between the measurement holder 112 and the Z reference mirror 108, i.e. a relative displacement between the object P and the reference mirror. Each of the three displacement sensors detects the distance from the Z reference mirror 108, and therefore the vibration of the measurement holder 112 with respect to the Z reference mirror 108 (a relative vibration) can be calculated. More specifically, the displacement of the measurement holder 112 in a Z-axis direction and amounts of rotation around the X axis and the Y axis can be calculated. If the object P and the measurement holder 112 are not integrated to perform the rigid-body mode, the plurality of displacement sensors described above may also be directly attached to the object P.

The position of the surface F that is measured by the Z-axis interferometer 110 (a measured value) is sent to a processor 115 (a calculator). Signals from the first displacement sensor 114a, the second displacement sensor 114b, and the third displacement sensor that is not shown, i.e. the relative displacement between the object P and the reference mirror, are also sent to the processor 115. The processor 115 calculates vibration data (the relative displacement) of the measurement holder 112 based on the signal from the displacement sensor, and obtains a correction value that is used to correct the measured value obtained from the Z-axis interferometer 110. The processor 115 corrects the measured value of the Z-axis interferometer 110 using this correction value to obtain the shape of the object P (the surface shape data of the surface F) in which the error contained in the measured value is corrected, i.e. the influence of the vibration is removed.

Thus, the processor 115 calculates the shape of the object P using the relative displacement between the object P and the reference mirror that is obtained based on the measured value obtained by scanning the probe 101 and the signal from the sensor. In the present embodiment, specifically, the sensor is a displacement sensor that detects the relative displacement between the object P and the reference mirror. The processor 115 corrects the measured value using the relative displacement that is detected by the displacement sensor, and calculates the shape of the object.

As above, according to the present embodiment, a measurement apparatus capable of measuring a shape of an object using a displacement sensor with high accuracy even when a relative displacement is generated between a reference mirror and the object can be provided.

### Embodiment 2

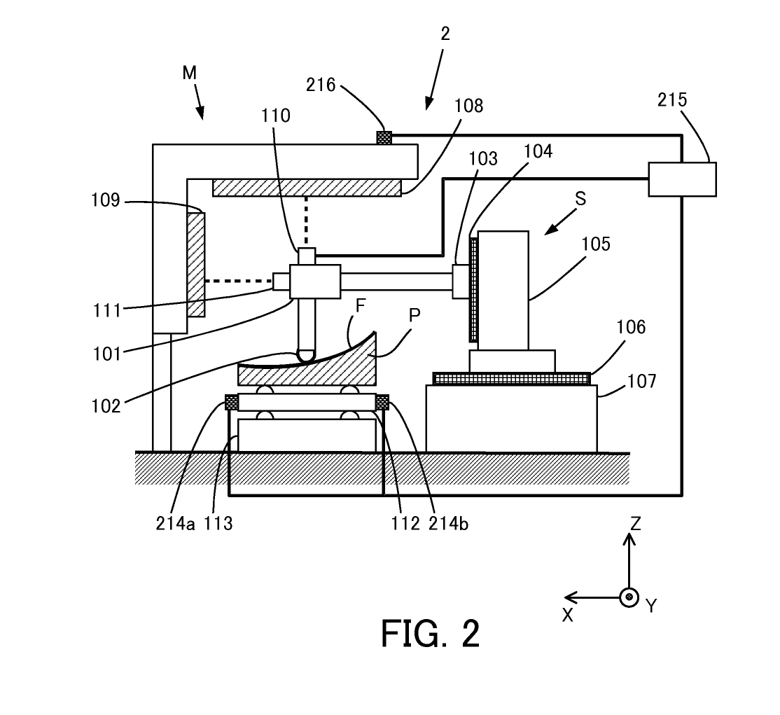

Next, a measurement apparatus in Embodiment 2 of the present invention will be described. FIG. 2 is a configuration diagram of a measurement apparatus 2 in the present embodiment. The measurement apparatus 2 includes a first acceleration sensor 214a, a second acceleration sensor 214b, and a third acceleration sensor that is not shown, instead of the first displacement sensor 114a, the second displacement sensor 114b, and the third displacement sensor, respectively. Furthermore, the measurement apparatus 2 includes a first reference acceleration sensor 216, and a second reference acceleration sensor and a third reference acceleration sensor that are not shown. An output signal of each reference acceleration sensor is, similarly to each acceleration sensor, sent to a processor 215. Other configurations of the measurement apparatus 2 are similar to those of the measurement apparatus 1 of Embodiment 1, and therefore the descriptions are omitted.

In FIG. 2, it is assumed that the object P and the measurement holder 112 are integrated with each other to perform a rigid-body mode vibration. In addition, it is assumed that the metrology frame M and each of the reference mirrors are also integrally vibrated. The measurement holder 112 is provided with the first acceleration sensor 214a, the second acceleration sensor 214b, and the third acceleration sensor that is not shown (hereinafter, collectively, also referred to as an acceleration sensor or a sensor). The metrology frame M is provided with the first reference acceleration sensor 216 and the second reference acceleration sensor and the third reference acceleration sensor that are not shown (hereinafter, collectively, also referred to as a reference acceleration sensor or a sensor). Each of these acceleration sensor and reference acceleration sensors can measure one to three axial accelerations.

In the embodiment, the vibrations of the measurement holder 112 in at least three axis directions can be measured by the three acceleration sensors. Similarly, the vibrations of the metrology frame M in at least three axis directions can be measured by the three reference acceleration sensors. If the object P and the measurement holder 112 are not integrated so as to perform the rigid-body mode vibration, the plurality of acceleration sensors may also be directly attached to the object P. If the metrology frame M and each reference mirror are not integrated so as to perform the rigid-body mode vibration, the plurality of acceleration sensors may also be directly attached to each reference mirror.

The measured value of the surface F that is measured by the Z-axis interferometer 110 is sent to the processor 215. The signals from the first acceleration sensor 214a, the second acceleration sensor 214b, and the third acceleration sensor that is not shown are also sent to the processor 215. In addition, the signals from the first reference acceleration sensor 216 and the second reference acceleration sensor and the third reference acceleration sensor that are not shown are sent to the processor 215. The processor 215 calculates vibration data of the measurement holder 112 (a first displacement) and vibration data of the metrology frame M (a second displacement) based on the signals from these acceleration sensors and reference acceleration sensors. Then, the processor 215 corrects the measured value of the Z-axis interferometer 110 based on the relative displacement obtained from the first displacement and the second displacement so as to calculate the shape of the object P.

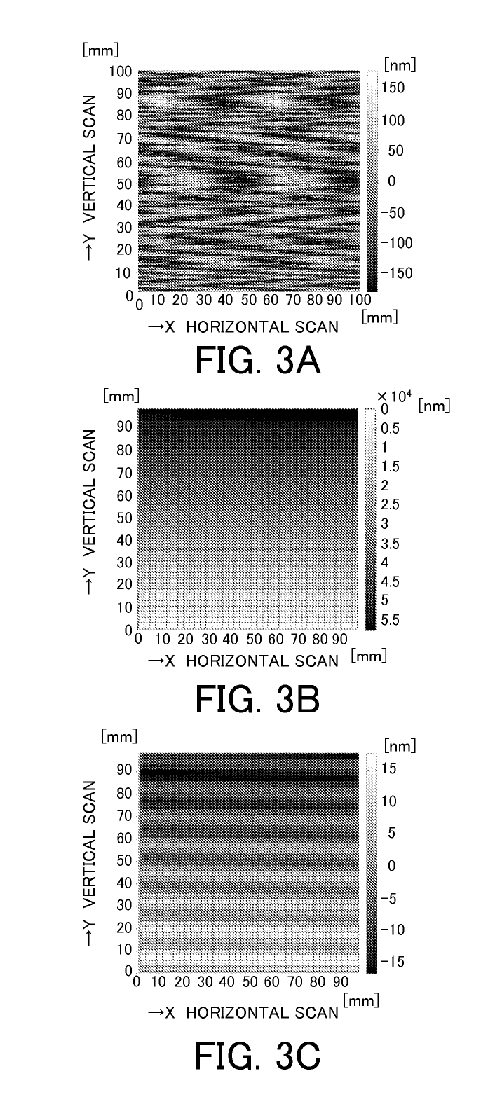

Next, referring to FIGS. 3A to 3C, a method of calculating the correction value based on the signal (the measurement data) from each acceleration sensor will be described. FIGS. 3A to 3C are one example of the relative displacement (a simulation result) that is obtained based on the signal from the acceleration sensor. FIG. 3A is measurement data in a region of a vertical and lateral directions of 100 [mm]. It is assumed that the surface F of the object P is an ideal flat surface. As a measurement model, first of all, a line scanning of the probe 101 is performed from a point of (X, Y)=(0, 0) in the X-axis direction that is a lateral direction so as to obtain line data. When the data in one line have been obtained, sequentially, the line scanning in the X-axis direction is performed up to a point of (100, 100) while performing a step movement of 2.5 [mm] in the Y-axis direction. The X-axis direction and the Y-axis direction are called a main scanning direction (a horizontal direction) and vertical scanning direction, respectively. The number of data is 40 points×40 lines, a line scan speed is 10 [mm/s], a sampling frequency of the data is 4 [Hz].

When the relative vibration (the relative displacement) is generated between the object P and the metrology frame M, the measurement data contain an error that is caused by this relative vibration. In FIG. 3A, a vibration of 6.25 [μm/sRMS] that is the VC-D standard is set as the relative vibration. As a representative vibration, the embodiment is focused on a vibration having a frequency of 0.2 [Hz]. Based on the scan speed of the probe 101, two peaks are generated by the vibration in one line, and a surface shape error appears as illustrated in FIG. 3A if this is not removed. This case corresponds to the surface shape error of 127 nmRMS.

In order to correct the error caused by this vibration, in the present embodiment, the relative acceleration between the object P and the reference mirror is used. The second order integration of the relative acceleration is performed to be able to calculate the relative displacement between the object P and the reference mirror. Commonly, when the integral processing is performed, a direct-current component or an extremely-low frequency vibrational component of the relative acceleration needs to be removed, but in the present embodiment, the second order integration of the relative acceleration is directly performed without performing this processing.

The second order integration of the relative acceleration is directly performed, and therefore the integrated data contain an error caused by the integration. First of all, a case in which the direct-current error component of the relative acceleration is set to zero is considered. When a relative acceleration G₁ is a sine-wave vibration having a period cot, a relative displacement D₁ is represented as the following Expression (1).

$$\begin{matrix}{D}_{1} = {\int \int }_{A} {G}_{1} d t d t \\ = {\int \int }_{A} L sin ω t d t d t \\ = L {ω}^{2} sin ω t + {C}_{1} t + {C}_{2}\end{matrix} \qquad ( 1 )$$

The relative displacement D₁ is a value that is obtained by integrating the relative acceleration G₁ in a measurement interval A. FIG. 3B is a result that is obtained by subtracting the relative displacement D₁ as it is from the measurement data of FIG. 3A. When a difference processing is performed, the error in the scanning direction as can be seen in FIG. 3A is reduced. However, a large integration error is generated in the vertical direction.

In the measurement apparatus 2 of the present embodiment, it is not necessary to measure an absolute position or an inclination of the object P. When the object P is inclined, shape data can only be obtained by applying a predetermined inclination processing to the measurement data. In other words, a term of “C₁t+C₂” in Expression (1) can be ignored.

Referring to FIG. 3B, the integration error contains a substantially linear inclination, and this inclination is recognized as a linear component that is represented by C₁t+C₂. FIG. 3C is a result that is obtained by correcting the inclination of the measurement data. FIG. 3C represents a residual error after the correction in the present embodiment. A correction result is 8.6 nmRMS, which is improved by 93% compared to the result obtained before the correction. Thus, in the above example, the second order integration of the relative acceleration may be applied as the correction value (a measured coordinate correction value).

On the other hand, when the calibration of the acceleration sensor is insufficient or a noise of an electric system is contained, the direct-current error component of the acceleration is not zero. Therefore, next, such a case will be considered. In the embodiment, a case in which the direct-current error component of 10% with respect to the peak of the acceleration is contained will be considered. When the direct-current component is C_{d}, the relative displacement D₂ is represented by the following Expression (2).

$$\begin{matrix}{D}_{2} = {\int \int }_{A} {G}_{2} d t d t \\ = {\int \int }_{A} ( L sin ω t + {C}_{d} ) d t d t \\ = L {ω}^{2} sin ω t + \frac{1}{2} {C}_{d} {t}^{2} + {C}_{1} t + {C}_{2}\end{matrix} \qquad ( 2 )$$

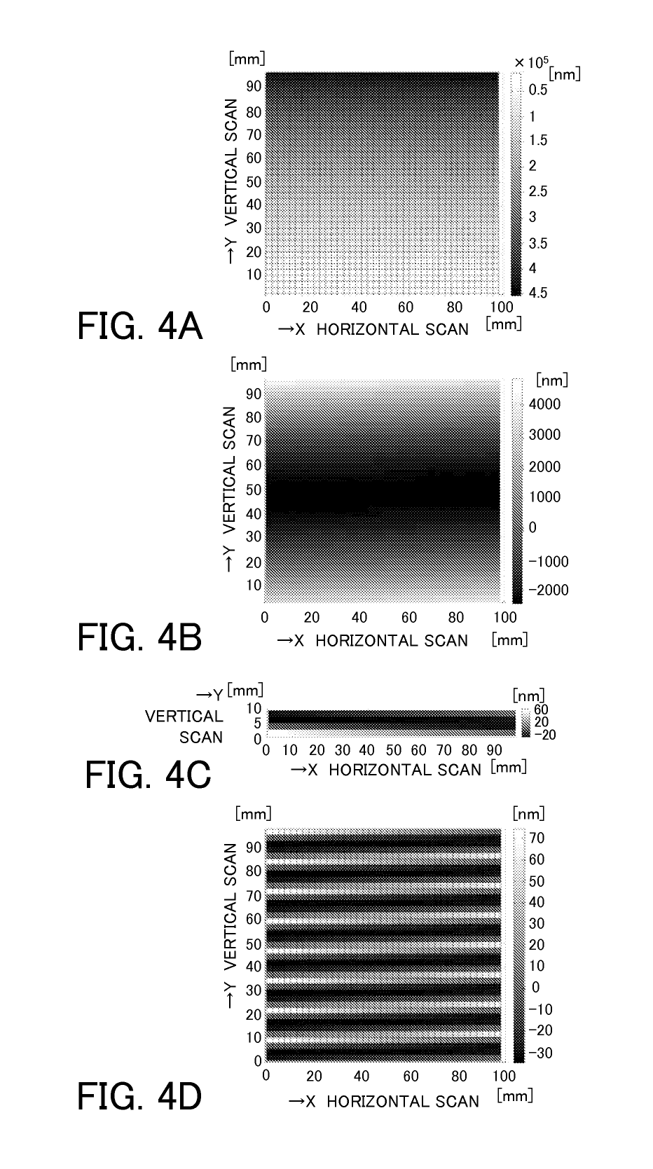

The relative displacement D₂ is a value that is obtained by integrating the relative acceleration G₂ in the measurement interval A. FIG. 4A is a result that is obtained by subtracting the relative displacement D₂ as it is from the measurement data of FIG. 3A. When a difference processing is performed, the error in the scanning direction as can be seen in FIG. 3A is reduced. However, a large integration error is generated in the vertical direction, compared to the case where the direct-current component is zero. In other words, the integration error is substantially a parabolic surface, which is a component that is represented by the term of “(½)·C_{d}t²+C₁t+C₂” in Expression (2). FIG. 4B is a result that is obtained by correcting the inclination of the measurement data. Since a linear correction is applied to the parabolic surface, the parabolic shape cannot be fully corrected. In this case, the surface shape is 2159 nmRMS.

The direct-current component quadratically increases as the time passes. Therefore, a method of improving correction accuracy by narrowing the integration interval will be described. In the present simulation, five lines in the vertical direction are defined as the measurement intervals A1, A2, . . . , An. Since the time of 10 [s] is required for scanning one line, each measurement interval is 50 [s]. The relative displacement Dn in each measurement interval is represented by the following Expression (3).

$$\begin{matrix}Dn = {\int \int }_{An} {G}_{2} d t d t \\ = {\int \int }_{An} ( L sin ω t + {C}_{d} ) d t d t \\ = L {ω}^{2} sin ω t + \frac{1}{2} {C}_{d} {t}^{2} + {C}_{1 An} t + {C}_{2 An}\end{matrix} \qquad ( 3 )$$

FIG. 4C is a result that is obtained by removing the inclination from the relative displacement Dn. Since the time t is reset when the integration interval An is switched each time, the integration error is reduced. FIG. 4D is a result that is obtained by performing a divisional integration for all the integration intervals A and arranging them. FIG. 4D indicates the residual error of the correction in the present method. The correction result is 31 nmRMS, which is improved by 75% compared to the result obtained before the correction.

In the present embodiment, it is preferred that there is an improvement of around 75% with respect to the surface shape error. Therefore, in the present simulation, sufficient accuracy can be obtained even when the direct-current component of the relative acceleration is contained up to 10% of the maximum amplitude of the measured relative acceleration. More commonly, the accuracy can be maintained by narrowing the integration interval with respect to the maximum amplitude of the direct-current component of the relative acceleration.

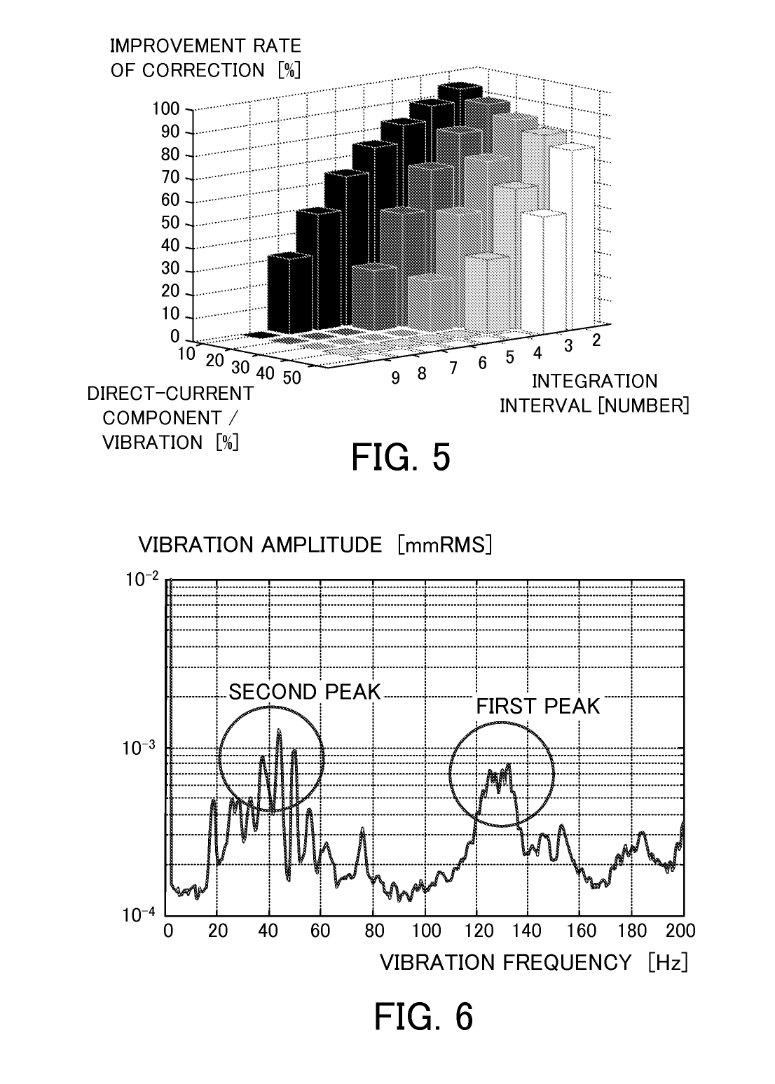

FIG. 5 is a diagram of a relation of an improvement rate of correction, a ratio of the direct-current component with respect to the amplitude of the vibration component, and the integration interval in the simulation of the present embodiment. The improvement rate of correction is deteriorated as the direct-current component increases. However, the improvement rate of correction is improved as the integration interval decreases. In the present embodiment, the integration interval may be set in accordance with an amount of the direct-current component so as to set the improvement rate of correction to be for example 75%. It is preferred that the amount of the direct-current component be previously confirmed before the measurement to adjust the integration interval in accordance with the amount of the direct-current component.

As above, in the present embodiment, similarly to Embodiment 1, the method of correcting the measured value of the object P using the relative displacement between the object P and the reference mirror is described. Subsequently, a case in which a frequency band of this correction value is limited will be described.

FIG. 6 is a graph of illustrating a relation (a measured value) between the vibration amplitude [mmRMS] of the object P mounted on the measurement apparatus 2 of the present embodiment and the vibration frequency [Hz]. In the graph of FIG. 6, roughly, two peaks exist. A first peak is a peak having a vibration frequency near 130[Hz]. The first peak indicates a vibration that is generated by the deformation of the object P (an elastic vibration), which is a lowest-order elastic mode frequency of the object P itself. A second peak indicates a peak having the vibration frequency near 40[Hz]. The second peak is not generated by the object P or the measurement holder 112 alone, and it is generated by the influence of a connecting portion between the object P and the measurement holder 112 or the like. In other words, the second peak indicates a mode frequency at which the object P performs a rigid-body vibration, which is a rigid-body mode frequency of the object P.

A condition required to measure the object P will be described. When the object P performs the elastic vibration, the elastic vibration is the shape error of the object P itself, and therefore it is preferred that this elastic vibration be cut. On the other hand, when the object P performs the rigid-body vibration, the shape of the object P is not deformed, and therefore it is preferred that the correction be performed using the method in the present embodiment. In addition, it is preferred that the vibration having a frequency lower than or equal to a predetermined level and the direct-current component be cut in order to improve the measurement accuracy.

Accordingly, in the present embodiment, in order to remove the vibration frequency near the first peak, the vibration frequency not less than the lowest-order elastic mode of the object P itself (for example a vibration frequency not less than 100 Hz) needs only to be cut using a low-pass filter. As a result, the error that is generated by the deformation of the shape of the object P can be reduced. The first peak can be actually measured by the measurement apparatus 2. Alternatively, a natural mode that is calculated by a finite element analysis of the object P or the like may also be used. In the present embodiment, furthermore, the vibration less than or equal to the vibration frequency near the second peak, i.e. the vibration less than or equal to the vibration frequency generated by the influence of the contact portion between the object P and the measurement holder 112 or the like (for example, a vibration frequency less than or equal to 20 Hz) may be cut using a high-pass filter. As a result, the error that is generated by the extremely-low frequency vibration or the direct-current component can be reduced.

The sensor of the present embodiment is the acceleration sensor that detects the relative acceleration between the object P and the reference mirror. The processor 215 performs the second order integration so as to calculate the relative displacement between the object P and the reference mirror. Then, the processor 215 corrects the measured value using the relative displacement so as to calculate the shape of the object P. In addition, the processor 215 removes the error component contained in the corrected measured value as a translation or an inclination of the object P from the corrected measured value so as to calculate the shape of the object P. The processor 215 also includes a bandpass filter (the low-pass filter) that is capable of changing a cutoff frequency, and the shape of the object P is calculated after the lowest-order natural frequency of the object P is removed by the bandpass filter. Furthermore, in order to reduce the error that is generated by the extremely-low frequency or the direct-current component, it is preferred that the high-pass filter that removes the frequency less than the lowest-order natural frequency of the object P be used.

As above, according to the present embodiment, a measurement apparatus capable of measuring a shape of an object using an acceleration sensor with high accuracy even when a relative displacement is generated between a reference mirror and the object can be provided.

### Embodiment 3

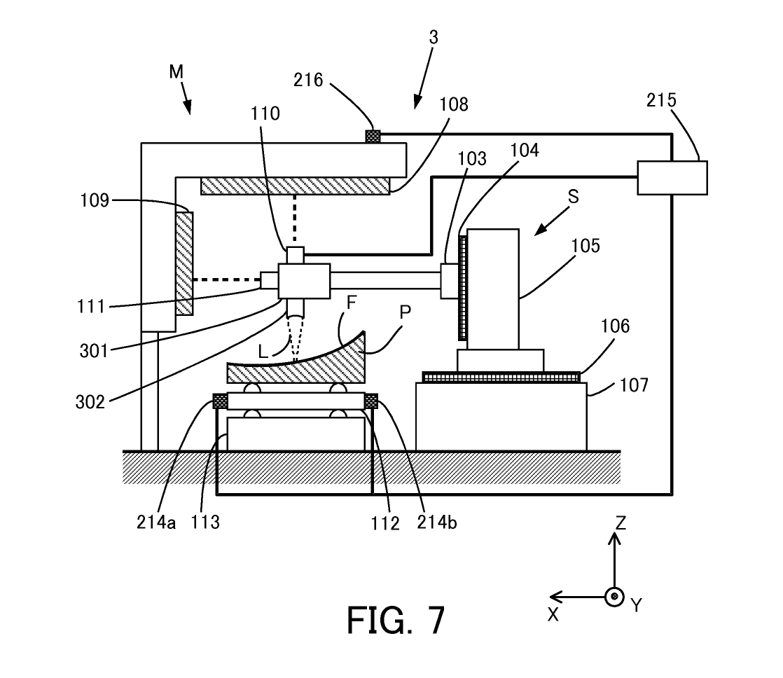

Next, referring to FIG. 7, a measurement apparatus in Embodiment 3 of the present invention will be described. FIG. 7 is a configuration diagram of a measurement apparatus 3 in the present embodiment. The measurement apparatus 3 of the present embodiment is different from the measurement apparatus 2 of Embodiment 2 in that a probe 301 (a non-contact probe) including a non-contact sensor 302 that scans the object P without contacting the object P is provided, instead of the probe 101 including the probe end ball 102. Other configurations of the measurement apparatus 3 are similar to those of the measurement apparatus 2 of Embodiment 2, and therefore the descriptions are omitted.

The non-contact sensor 302 illuminates measurement light L on the object P so as to measure a distance between the non-contact sensor 302 and the object P using reflected light of the measurement light L. When a highly-accurate measurement is required, it is preferred that the non-contact sensor 302 be configured by an interferometer. In the present embodiment, a so-called cat's-eye measurement in which the measurement light L is converged via an objective lens (not shown) so as to reflect the measured light at a focus position is performed, but the embodiment is not limited to this. For example, the measurement light L may also be illuminated on the surface F as a plane wave without being converged, or alternatively, it may be illuminated on the surface F as divergent light. The measurement light L may also be configured by a plurality of rays of a double-pass interferometer or the like.

According to the present embodiment, a measurement apparatus capable of measuring a shape of an object using a non-contact probe with high accuracy even when a relative displacement is generated between a reference mirror and the object can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In each of the embodiments described above, the reference mirror is held on the metrology frame M that is provided separately from the mount stage 113, but the embodiment is not limited to this. Even when the reference mirror is not separated from the mount stage 113, i.e. it is held on the metrology frame that is mechanically connected, the measurement accuracy can be improved and each of the embodiments described above can be applied. In each of the embodiments described above, a displacement sensor or an acceleration sensor is used as a sensor that calculates a relative displacement between the object and the reference mirror, but the embodiment is not limited to this, and for example a speed sensor may also be used.

This application claims the benefit of Japanese Patent Application No. 2012-019884, filed on Feb. 1, 2012, which is hereby incorporated by reference herein in its entirety.

What is claimed is:

1. A measurement apparatus comprising:
a mount configured to mount an object;
a probe configured to move with respect to the object so as to measure a shape of the object;
an interferometer configured to measure a position of the probe with respect to a reference mirror; and
a calculator configured to calculate the shape of the object using a measured value relating to the shape of the object that is obtained based on the position of the probe measured by the interferometer and a relative displacement between the object and the reference mirror that is obtained based on a signal from a sensor for the object and the reference mirror while the probe is moved,
wherein the sensor is an acceleration sensor that detects a relative acceleration between the object and the reference mirror,
wherein the calculator performs a second order integration of the relative acceleration so as to calculate the relative displacement between the object and the reference mirror, and corrects the measured value using the relative displacement so as to calculate the shape of the object, and
wherein the calculator removes an error component contained in corrected measured value as a translation and an inclination of the object from the corrected measured value so as to calculate the shape of the object.

2. The measurement apparatus according to claim 1,
wherein the sensor is a displacement sensor that detects the relative displacement between the object and the reference mirror, and
wherein the calculator corrects the measured value using the relative displacement that is detected by the displacement sensor so as to calculate the shape of the object.

3. The measurement apparatus according to claim 1, wherein the reference mirror is held on a measurement frame that is provided separately from the mount.

4. The measurement apparatus according to claim 1, wherein the calculator includes a bandpass filter capable of changing a cutoff frequency, and calculates the shape of the object after removing a lowest-order natural frequency of the object using the bandpass filter.

5. The measurement apparatus according to claim 1,
wherein the calculator includes a bandpass filter capable of changing a cutoff frequency,
wherein the cutoff frequency of the bandpass filter is set so that a rigid-body mode frequency of the object is not removed and a lowest-order elastic mode frequency of the object is removed, and
wherein the calculator calculates the shape of the object using the bandpass filter.

6. The measurement apparatus according to claim 1, wherein the probe is a contact probe that moves along the object while contacting the object.

7. The measurement apparatus according to claim 1, wherein the probe is a non-contact probe that moves with respect to the object without contacting the object.
